(19) United States
(12) Patent Application Publication
(10) Pub. No.: US 2009/0039826 A1
(43) Pub. Date: Feb. 12, 2009

(54) SOLAR ENERGY CHARGING/DISCHARGING SYSTEM AND CHARGING/DISCHARGING METHOD THEREOF

(76) Inventors: Jer-Liang Yeh, Taichung City (TW); Jia-Yan Lee, Taipei City (TW)

Correspondence Address: Muncy, Geissler, Olds & Lowe, PLLC, P.O. BOX 1364, FAIRFAX, VA, 22038-1364, US

(21) Appl. No.: 12/188,005

(22) Filed: Aug. 7, 2008

(30) Foreign Application Priority Data
Aug. 8, 2007 (TW) 096129130

(51) Int. Cl. H02J 7/00

(52) U.S. Cl. 320/101

(57) ABSTRACT

The invention discloses a solar energy charging/discharging system and a charging/discharging method thereof. The solar energy charging/discharging system according to the invention comprises a solar cell, a super-capacitor, and a switch. The solar cell is used for collecting solar energy and converting the solar energy into electrical energy. The super-capacitor is coupled to the solar cell. The super-capacitor and the solar cell are coupled to a load through the switch. The super-capacitor is selectively charged/discharged according to a threshold voltage.

### BACKGROUND OF THE INVENTION

1. Field of the Invention

The invention relates to a solar energy charging/discharging system and a charging/discharging method based on a solar cell.

2. Description of the Prior Art

A solar cell can convert light energy from a light source (e.g. sunlight) into electrical energy for equipment (e.g. calculator, computer, household appliances, etc.). In general, the solar cell is widespread in common usage.

Please refer to FIG. 1. FIG. 1 is a characteristic curve diagram illustrating a relation between power and voltage under different sunlight degree. As shown in FIG. 1, a power generating performance under high sunlight density is properly better than a performance under low sunlight density. Besides, the curve 1/Z_{L} in FIG. 1 is a characteristic curve represents the reciprocal of a load impedance of the solar cell. The load can be a current converter, a storage (e.g. rechargeable battery), or a household appliances, etc.

It should be noticed that the intersection between the curve 1/Z_{L} and the characteristic curve of the solar cell represents an operating voltage of the solar cell. In FIG. 1, the solar cell can be operated at an operating voltage P1, which approximates a maximum operating voltage, under high sunlight density. However, the solar cell can be only operated at a low operating voltage P2 under low sunlight density, such that it significantly decreases the power generating performance.

In the prior art, a periodical, namely Solar Energy 81 (2007) 31-38, had disclosed a Maximum Power Point Tracking (MPPT) system for adjusting an operating voltage of the solar cell. Please refer to FIG. 2. FIG. 2 is a schematic diagram illustrating the MPPT system. The MPPT system utilizes a direct current (DC) to direct current converter associated with appropriate software to detect and adjust an output voltage V1 and an output current Ii, such that the solar cell can be always operated under maximum power. However, this system has some disadvantages of high producing cost and great complexity.

According to statistics, there are around 200 sunny days per year, and there are only 4 hours, from 10 AM to 2 PM (high sunlight density period), in a day that the solar cell can be operated at maximum operating voltage. In other words, the conventional solar cell can be only operated at maximum operating voltage with 800 hours per year due to the limited load. Therefore, it is necessary to enable the solar cell to be operated at the maximum operating voltage under low sunlight density, so as to improve the performance of the solar cell.

Therefore, the main scope of the invention is to provide a solar energy charging/discharging system and a charging/discharging method thereof to solve the aforesaid problems.

### SUMMARY OF THE INVENTION

A scope of the invention is to provide a solar energy charging/discharging system and a charging/discharging method based on a solar cell.

According to an embodiment of the invention, the solar energy charging/discharging system comprises a solar cell, a super-capacitor, and a switch.

The solar cell is used for collecting a solar energy and converting the solar energy into an electric energy. The super-capacitor is coupled to the solar cell. The super-capacitor and the solar cell are coupled to a load through the switch. The super-capacitor is selectively charged or discharged according to a threshold voltage.

According to another embodiment, the invention discloses a charging/discharging method based on a solar cell. The solar cell is used for collecting a solar energy and converting the solar energy into an electric energy. A super-capacitor is coupled to the solar cell. The super-capacitor and the solar cell are coupled to a load through a switch.

First of all, the method detects an across voltage of the super-capacitor first. Afterward, the method compares the across voltage with a threshold voltage. If the across voltage is lower than the threshold voltage, the method switches on the switch to activate the solar cell charging the super-capacitor with the electric energy.

According to another embodiment, the invention discloses a solar energy charging/discharging system. The solar energy charging/discharging system comprises a solar cell, a first super-capacitor, and a second super-capacitor.

The solar cell is used for collecting a solar energy and converting the solar energy into an electric energy. The first super-capacitor is coupled to the solar cell through a first switch and coupled to a load through a second switch. The solar cell is coupled to the load through the first switch and the second switch. The second super-capacitor is coupled to the solar cell through a third switch and coupled to the load through a fourth switch. The solar cell is coupled to the load through the third switch and the fourth switch.

Compared to the prior art, the solar energy charging/discharging system of the invention provides the electric energy to a super-capacitor with lower impedance under lower sunlight density. Due to low impedance of the super-capacitor, the solar cell can be operated at a voltage approximating to the maximum operating voltage. Therefore, no matter under high or low sunlight density, the solar energy charging/discharging system of the invention is capable of being operated at a voltage approximating to the maximum operating voltage, so as to improve the performance of the solar cell.

The advantage and spirit of the invention may be understood by the following recitations together with the appended drawings.

### BRIEF DESCRIPTION OF THE APPENDED DRAWINGS

FIG. 1 is a characteristic curve diagram illustrating a relation between power and voltage under different sunlight degree.

FIG. 2 is a schematic diagram illustrating the Maximum Power Point Tracking (MPPT) system.

FIG. 3A is a schematic diagram illustrating a solar energy charging/discharging system according to an embodiment of the invention.

FIG. 3B shows an extending embodiment of the solar energy charging/discharging system shown in FIG. 3A.

FIG. 4 is a characteristic curve diagram illustrating a relation between power and voltage of the solar energy charging/discharging system of the invention under different sunlight degree.

FIG. 5 shows a relation between power and time measured when the solar energy charging/discharging system of the invention and a single solar cell respectively provide electricity to the load.

FIG. 6 is a flow chart illustrating a charging/discharging method based on the solar cell according to another embodiment of the invention.

FIG. 7A is a schematic diagram illustrating a solar energy charging/discharging system according to another embodiment of the invention.

FIG. 7B shows an extending embodiment of the solar energy charging/discharging system shown in FIG. 7A.

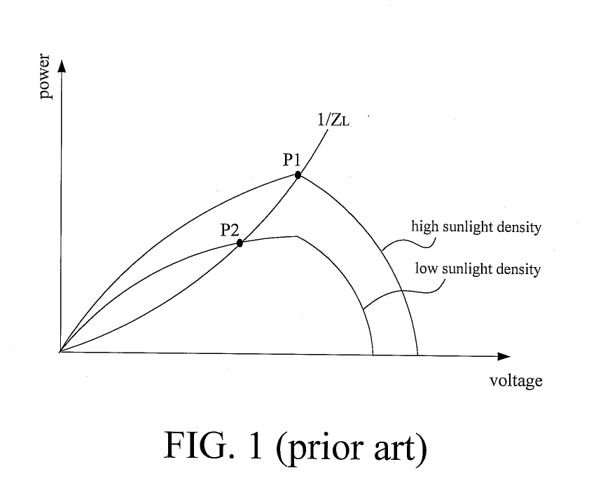

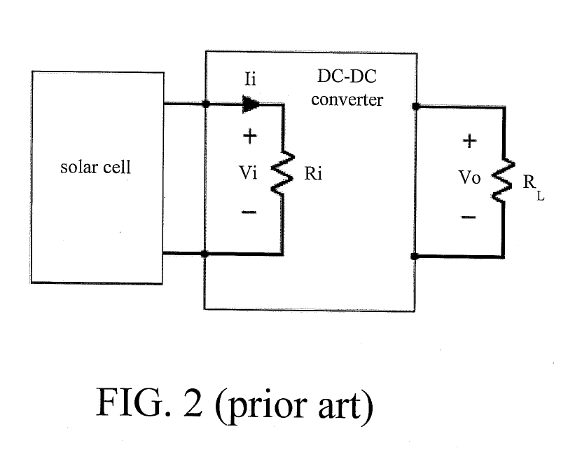

### DETAILED DESCRIPTION OF THE INVENTION

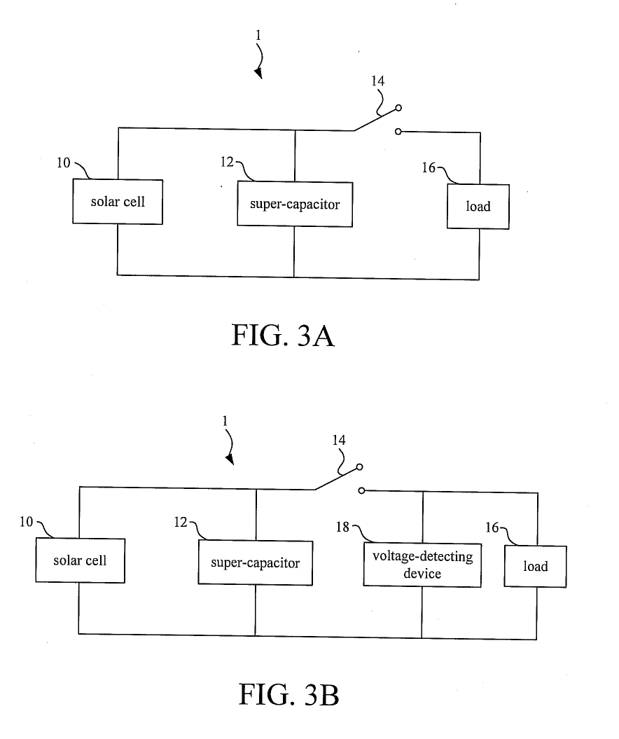

Please refer to FIG. 3A. FIG. 3A is a schematic diagram illustrating a solar energy charging/discharging system 1 according to an embodiment of the invention.

As shown in FIG. 3A, the solar energy charging/discharging system 1 comprises a solar cell 10, a super-capacitor 12, and a switch 14.

The super-capacitor 12 is an energy storage with high power capacity, high energy density. The super-capacitor 12 has the following advantages: 1) the capacitance unit is at Farad (F) scale, which is one million times a capacitance of a regular capacitor; 2) the charging/discharging rate is faster than a battery; 3) the charging/discharging times can reach one hundred thousand times, but a conventional rechargeable battery just can be charged or discharged with 300 to 2000 times; and 4) the load is extremely low.

The solar cell 10 is used for collecting a solar energy and converting the solar energy into an electric energy. The super-capacitor 12 is coupled to the solar cell 10. The super-capacitor 12 and the solar cell 10 are coupled to a load 16 through the switch 14. The super-capacitor 12 is selectively charged or discharged according to a threshold voltage.

In practical application, the load 16 can be, but not limited to, a current converter (e.g. DC to DC converter or DC to AC converter), a storage (e.g. rechargeable battery), or a household appliances.

Please refer to FIG. 3B. FIG. 3B shows an extending embodiment of the solar energy charging/discharging system 1 shown in FIG. 3A. As shown in FIG. 3B, the solar energy charging/discharging system 1 further comprises a voltage-detecting device 18 for detecting a across voltage of the super-capacitor 12. When the across voltage of the super-capacitor 12 is lower than the threshold voltage, the switch 14 is switched on to activate the solar cell 10 charging the super-capacitor 12 with the electric energy. When the super-capacitor 12 is fully charged, the switch 14 is switched off to activate the solar cell 10 and the super-capacitor 12 supplying electricity to the load 16. When the across voltage of the super-capacitor 12 is lower than the threshold voltage, the switch 14 is switched on again, so as to activate the solar cell 10 charging the super-capacitor 12 with the electric energy again.

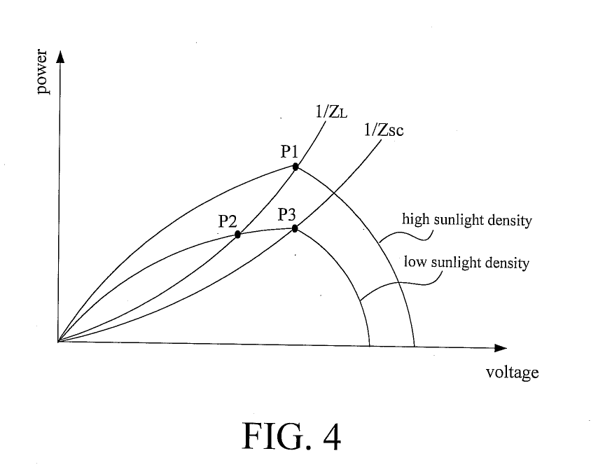

Please refer to FIG. 4. FIG. 4 is a characteristic curve diagram illustrating a relation between power and voltage of the solar energy charging/discharging system 1 of the invention under different sunlight degree.

As shown in FIG. 4, a curve 1/Z_{SC} represents a reciprocal impedance characteristic curve of the super-capacitor 12, and a curve 1/Z_{L} represents a reciprocal impedance characteristic curve of the load 16. Due to the super-capacitor 12 with higher impedance at low frequency, the solar cell 10 can be operated at a voltage P3 approximating to the maximum operating voltage under low sunlight density, and the solar cell 10 can store the electric energy into the super-capacitor 12 in advance for further utilization. In comparison, if the solar cell 10 supplied electricity to the load 16 under low sunlight density, the solar cell 10 can be only operated at a lower operating voltage P2, resulting in a lower power generating performance.

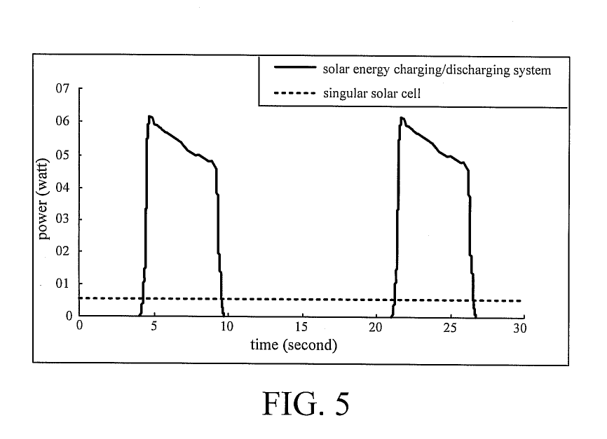

Please refer to FIG. 5. FIG. 5 shows a relation between power and time measured when the solar energy charging/discharging system of the invention and a single solar cell respectively provide electricity to the load. As shown in FIG. 5, the average power that a single solar cell provides to a load is around 0.056 watt (i.e. the horizontal dashed line at the bottom of FIG. 5). In comparison, the solar energy charging/discharging system of the invention has a maximum power, which can reach 0.532 watt, and an average power, which can reach 0.145 watt. It is obviously greater than 0.056 watt, which is the average power from the single solar cell. Therefore, as a matter of fact, the solar energy charging/discharging system of the invention has higher performance, indeed.

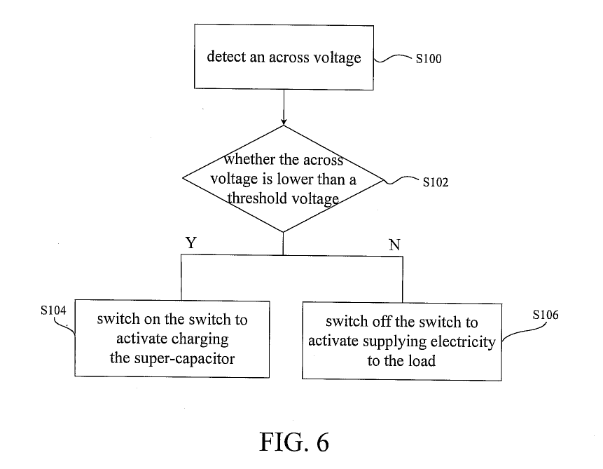

Please refer to FIG. 6 associated with FIG. 3. FIG. 6 is a flow chart illustrating a charging/discharging method based on the solar cell 10 according to another embodiment of the invention.

The solar cell 10 is used for collecting a solar energy and converting the solar energy into an electric energy. A super-capacitor 12 is coupled to the solar cell 10. The super-capacitor 12 and the solar cell 10 are coupled to a load 16 through a switch 14.

First, step S100 of the method is performed to detect an across voltage of the super-capacitor 12.

Afterward, step S102 of the method is performed to compare the across voltage with a threshold voltage.

If the across voltage is lower than the threshold voltage, step S104 of the method is then performed to switch on the switch 14 to activate the solar cell 10 charging the super-capacitor 12 with the electric energy.

When the super-capacitor 12 is fully charged, which means that the across voltage of the super-capacitor 12 exceeds the threshold voltage, step S106 of the method is then performed to switch off the switch 14 to activate the solar cell 10 and the super-capacitor 12 supplying electricity to the load 16.

Once the across voltage of the super-capacitor 12 is lower than the threshold voltage because of discharging, the method of the invention will switch on the switch 14 again to activate the solar cell 10 charging the super-capacitor 12.

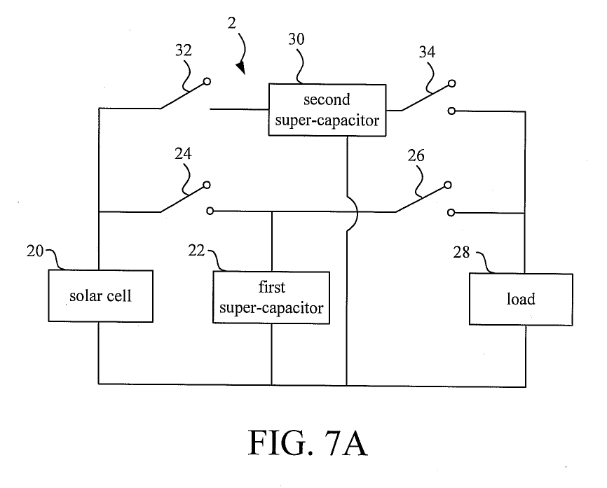

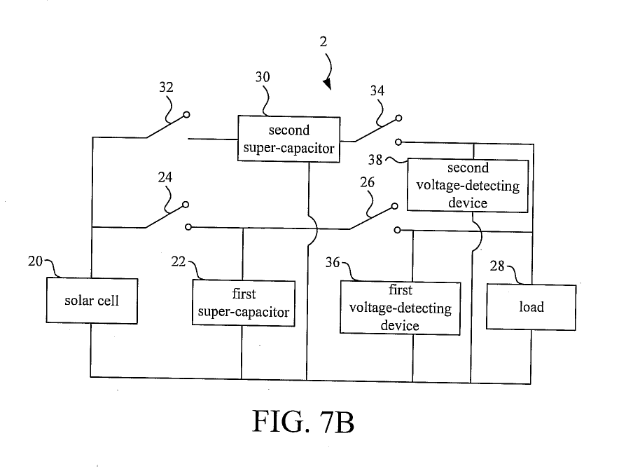

Please refer to FIG. 7A. FIG. 7A is a schematic diagram illustrating a solar energy charging/discharging system 2 according to another embodiment of the invention.

As shown in FIG. 7A, the solar energy charging/discharging system 2 comprises a solar cell 20, a first super-capacitor 22, and a second super-capacitor 30.

The solar cell 20 is used for collecting a solar energy and converting the solar energy into an electric energy. The super-capacitor 22 is coupled to the solar cell 20 through a first switch 24 and coupled to a load 28 through a second switch 26. The solar cell 20 is coupled to the load 28 through the first switch 24 and the second switch 26. The second super-capacitor 30 is coupled to the solar cell 20 through a third switch 32 and coupled to the load 28 through a fourth switch 34. The solar cell 20 is coupled to the load 28 through the third switch 32 and the fourth switch 34.

The first super-capacitor 22 is selectively charged or discharged according to a first threshold voltage, and the second super-capacitor 30 is selectively charged or discharged according to a second threshold voltage.

Please refer to FIG. 7B. FIG. 7B shows an extending embodiment of the solar energy charging/discharging system 2 shown in FIG. 7A. As shown in FIG. 7B, the solar energy charging/discharging system 2 further comprises a first voltage-detecting device 36 and a second voltage-detecting device 38, which are respectively used for detecting a first across voltage of the first super-capacitor 22 and a second across voltage of the second super-capacitor 30.

When the first across voltage of the first super-capacitor 22 is lower than the first threshold voltage, the first switch 24 is switched off and the second switch 26 is switched on, so as to activate the solar cell 20 charging the first super-capacitor 22 with the electric energy.

When the first super-capacitor 22 is fully charged, the first switch 24 is switched on and the second switch 26 is switched off, so as to activate the first super-capacitor 22 supplying electricity to the load 28. When the first across voltage of the first super-capacitor 22 is lower than the first threshold voltage, the first switch 24 is switched off and the second switch 26 is switched on again.

When the second across voltage of the second super-capacitor 30 is lower than the second threshold voltage, the third switch 32 is switched off and the fourth switch 34 is switched on, so as to activate the solar cell 20 charging the second super-capacitor 30 with the electric energy.

When the second super-capacitor 30 is fully charged, the third switch 32 is switched on and the fourth switch 34 is switched off, so as to activate the second super-capacitor 30 supplying electricity to the load 28. When the second across voltage of the second super-capacitor 30 is lower than the second threshold voltage, the third switch 32 is switched off and the fourth switch 34 is switched on again.

Compared to the prior art, the solar energy charging/discharging system of the invention provides the electric energy to a super-capacitor with lower impedance under lower sunlight density. Due to low impedance of the super-capacitor, the solar cell can be operated at a voltage approximating to the maximum operating voltage. Therefore, no matter under high or low sunlight density, the solar energy charging/discharging system of the invention is capable of being operated at a voltage approximating to the maximum operating voltage, so as to improve the performance of the solar cell.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A solar energy charging/discharging system comprising:
a solar cell for collecting a solar energy and converting the solar energy into an electric energy;
a super-capacitor coupled to the solar cell; and
a switch, the super-capacitor and the solar cell being coupled to a load through the switch, wherein the super-capacitor is selectively charged or discharged according to a threshold voltage.

2. The solar energy charging/discharging system of claim 1, further comprising a voltage-detecting device for detecting an across voltage of the super-capacitor.

3. The solar energy charging/discharging system of claim 2, wherein the switch is switched on to activate the solar cell charging the super-capacitor with the electric energy when the across voltage is lower than the threshold voltage.

4. The solar energy charging/discharging system of claim 3, wherein the switch is switched off to activate the solar cell and the super-capacitor supplying electricity to the load when the super-capacitor is fully charged, and then, the switch is switched on again when the across voltage is lower than the threshold voltage.

5. The solar energy charging/discharging system of claim 1, wherein the load is a current converter.

6. The solar energy charging/discharging system of claim 1, wherein the load is an energy storage.

7. A charging/discharging method based on a solar cell, the solar cell being used for collecting a solar energy and converting the solar energy into an electric energy, a super-capacitor being coupled to the solar cell, the super-capacitor and the solar cell being coupled to a load through a switch, the method comprising steps of:
detecting an across voltage of the super-capacitor;
comparing the across voltage with a threshold voltage; and
switching on the switch to activate the solar cell charging the super-capacitor with the electric energy if the across voltage is lower than the threshold voltage.

8. The method of claim 7, further comprising step of:
switching off the switch to activate the solar cell and the super-capacitor supplying electricity to the load when the super-capacitor is fully charged.

9. The method of claim 8, further comprising step of:
switching on the switch again once the across voltage is lower than the threshold voltage.

10. The method of claim 7, wherein the load is a current converter.

11. The method of claim 7, wherein the load is an energy storage.

12. A solar energy charging/discharging system comprising:
a solar cell for collecting a solar energy and converting the solar energy into an electric energy;
a first super-capacitor coupled to the solar cell through a first switch and coupled to a load through a second switch, the solar cell being coupled to the load through the first switch and the second switch; and
a second super-capacitor coupled to the solar cell through a third switch and coupled to the load through a fourth switch, the solar cell being coupled to the load through the third switch and the fourth switch.

13. The solar energy charging/discharging system of claim 12, wherein the first super-capacitor is selectively charged or discharged according to a first threshold voltage, and the second super-capacitor is selectively charged or discharged according to a second threshold voltage.

14. The solar energy charging/discharging system of claim 13, further comprising a first voltage-detecting device and a second voltage-detecting device for detecting a first across voltage of the first super-capacitor and a second across voltage of the second super-capacitor, respectively.

15. The solar energy charging/discharging system of claim 14, wherein the first switch is switched off and the second switch is switched on to activate the solar cell charging the first super-capacitor with the electric energy when the first across voltage is lower than the first threshold voltage.

16. The solar energy charging/discharging system of claim 15, wherein the first switch is switched on and the second switch is switched off to activate the first super-capacitor supplying electricity to the load when the first super-capacitor is fully charged, and then, the first switch is switched off and the second switch is switched on when the first across voltage is lower than the first threshold voltage.

17. The solar energy charging/discharging system of claim 16, wherein the third switch is switched off and the fourth switch is switched on to activate the solar cell charging the second super-capacitor with the electric energy when the second across voltage is lower than the second threshold voltage.

18. The solar energy charging/discharging system of claim 17, wherein the third switch is switched on and the fourth switch is switched off to activate the second super-capacitor supplying electricity to the load when the second super-capacitor is fully charged, and then, the third switch is switched off and the fourth switch is switched on when the second across voltage is lower than the second threshold voltage.

19. The solar energy charging/discharging system of claim 12, wherein the load is a current converter.

20. The solar energy charging/discharging system of claim 12, wherein the load is an energy storage.
